(19) United States
(12) Patent Application Publication
(10) Pub. No.: US 2018/0072156 A1
(43) Pub. Date: Mar. 15, 2018

(54) A-Pillar Video Monitor System

(71) Applicant: WITH International, Inc., Rolling Meadows, IL (US)

(72) Inventors: Joon Hwan Tae, Elk Grove, IL (US); David Yang, Rolling Meadows, IL (US)

(21) Appl. No.: 15/265,079

(22) Filed: Sep. 14, 2016

(51) Int. Cl. B60K 35/00; B60R 1/00; B60R 21/213; B62D 25/04

(52) U.S. Cl. CPC B60K 35/00; B60R 1/00; B60R 2021/003; B62D 25/04; B60K 2350/921; B60R 21/213

(57) ABSTRACT

An embodiment of A-Pillar Video Monitor System is provided for a motor vehicle to permit the driver to view traffic conditions (e.g. running children, approaching cars, etc.) from sides of the vehicle. Left or right video cameras are mounted on the left sides or right sides of the motor vehicle. Each camera attachment has a miniature video camera viewing angle directed generally sides, and a housing or shroud that is in the form of an aerodynamic fairing disposed over the associated camera to protect the same and to minimize the amount of protuberance laterally from the side of the vehicle. The fairing also avoids unnecessary airflow turbulence, thereby streamlining the vehicle. The images viewed from these camera assemblies reproduced on a curved viewing screen or monitor, which is seamlessly integrated with A-Pillars of the vehicle. The driver can easily observe the conditions in all sides without having to divert his or her attention from the road ahead. In case of airbag activation, the curved monitor would opened to protect the driver and the airbag is deployed.

### STATEMENT REGARDING FEDERALLY SPONSORED RESEARCH OR DEVELOPMENT

Not Applicable

### FIELD

The present invention relates to an A-Pillar Video Monitor System, more specifically, a video monitor system with a video camera and curved monitor installed on A-Pillar.

### BACKGROUND

This invention relates generally to devices for left and right side viewing from vehicles such as passenger cars, trucks, or the like. The invention is more particularly concerned with video camera and viewing screen system which can provide a driver or other vehicle driver a view of traffic conditions to at least from right and left sides of the vehicle. Conventionally, passenger vehicles and trucks are provided with outside mirrors disposed at the left (driver) side and right (passenger) side of the vehicle, and in most cases with a rear view (center) mirror providing a view through the rear windscreen. These mirrors are necessary for safe vehicle operation and give the driver a view of traffic conditions behind the vehicle. The views from the right and left outside mirrors are especially useful to detect another vehicle in an adjacent lane, if the driver is planning to make a lane change or turn. These conventional mirrors have a number of drawbacks. For example, in order to look at the rearward traffic conditions in the right side mirror, the driver has to take his or her eyes off the road ahead and instead divert his or her attention onto the small view provided by the outside mirror. This is often done even while traffic conditions ahead are rapidly changing. However, for safe vehicle operation the need to divert one's attention from the road should be minimized. Also, the outside mirror adjustment depends on the driver position, and so if the driver adjusts the seat upwards or downwards, or back or forth, the outside mirrors also have to be readjusted. Adjusting the mirrors in traffic can be a dangerous maneuver. Also, A-Pillars, B-Pillars and C-Pillars prevent the driver in the car from seeing the objects or the passers-by. Further, because the mirrors are positioned to be in line with the driver's position, the driver's view in the outside mirrors does not always reveal another vehicle in an adjacent lane and even with the side of the vehicle (i.e., in a so-called blind spot). This occurrence of blind spots in the A-Pillars, B-Pillars, C-Pillars, rear view mirrors and outside mirrors has been an ongoing problem. The outside mirrors also produce significant amount of wind drag, because they project a substantial distance sideways from the vehicle. These mirrors are also subject to damage if the vehicle is driven or parked where there is only a small amount of sidewards clearance. Another problem with conventional mirrors arises during night-time operation. If another vehicle is approaching from the rear or overtaking, the mirrors reflect glare from that vehicle's headlights directly at the driver of the leading vehicle. Even if the other vehicle dims its lights, the amount of light reflected in the driver side outside mirror can produce enough glare to cause momentary night blindness. Shades or tinted glass can help to reduce glare, but these can also impair the normal rearward view. A number of proposals have appeared in recent times for supplementing a vehicle driver's view by use of a video camera mounted somewhere on the vehicle. These have generally involved mounting video cameras in box-like housings carried on arms that project from the vehicle. Typical of these are the arrangements described in U.S. Pat. Nos. 5,027,200; 4,910,591; and 3,689,695. Video viewing arrangements for viewing from the rear of a tractor trailer are described in U.S. Pat. Nos. 4,214,266 and 4,277,804. A camera arrangement from guiding a tractor or other farm vehicle is described in U.S. Pat. No. 4,288,814. However, these previous proposals do not suggest any practical solution to the problems encountered with conventional outside mirrors, A-Pillars, B-Pillars and C-Pillars.

### SUMMARY

A-Pillar Video Monitor System is provided for a motor vehicle to permit the driver to view traffic conditions (e.g. running children, approaching cars, etc.) from sides of the vehicle. Left or right video cameras are mounted on the left sides or right sides of the motor vehicle. Each camera attachment has a miniature video camera viewing angle directed generally sides, and a housing or shroud that is in the form of an aerodynamic fairing disposed over the associated camera to protect the same and to minimize the amount of protuberance laterally from the side of the vehicle. The fairing also avoids unnecessary airflow turbulence, thereby streamlining the vehicle. The images viewed from these camera assemblies reproduced on a curved viewing screen or monitor, which is seamlessly integrated with A-Pillars of the vehicle. The driver can easily observe the conditions to westward or to eastward without having to divert his or her attention from the road ahead. In case of airbag activation, the curved monitor would be opened to protect the driver and the airbag is deployed.

### BRIEF DESCRIPTION OF THE DRAWINGS

Various embodiments of the invention are disclosed in the following detailed description and accompanying drawings.

FIG. 1 is a system view of an A-Pillar Video Monitor System showing passer-by, camera, monitor and driver.

FIG. 2 is an inside view of a car without an A-Pillar Video Monitor System.

FIG. 3 is an inside view of a car with an A-Pillar Video Monitor System showing passer-by in an A-Pillar Video Monitor System.

FIG. 4 is an inside view of a car with an A-Pillar Video Monitor System showing passer-by in an A-Pillar Video Monitor System in case of airbag operation.

FIG. 5 is a perspective view of an A-Pillar Video Monitor System showing passer-by with a ball, video camera and driver.

### DETAILED DESCRIPTION OF THE INVENTION

The detailed description of the operation of A-Pillar Video Monitor System and magnets is explained in this section with reference to the accompanying drawings.

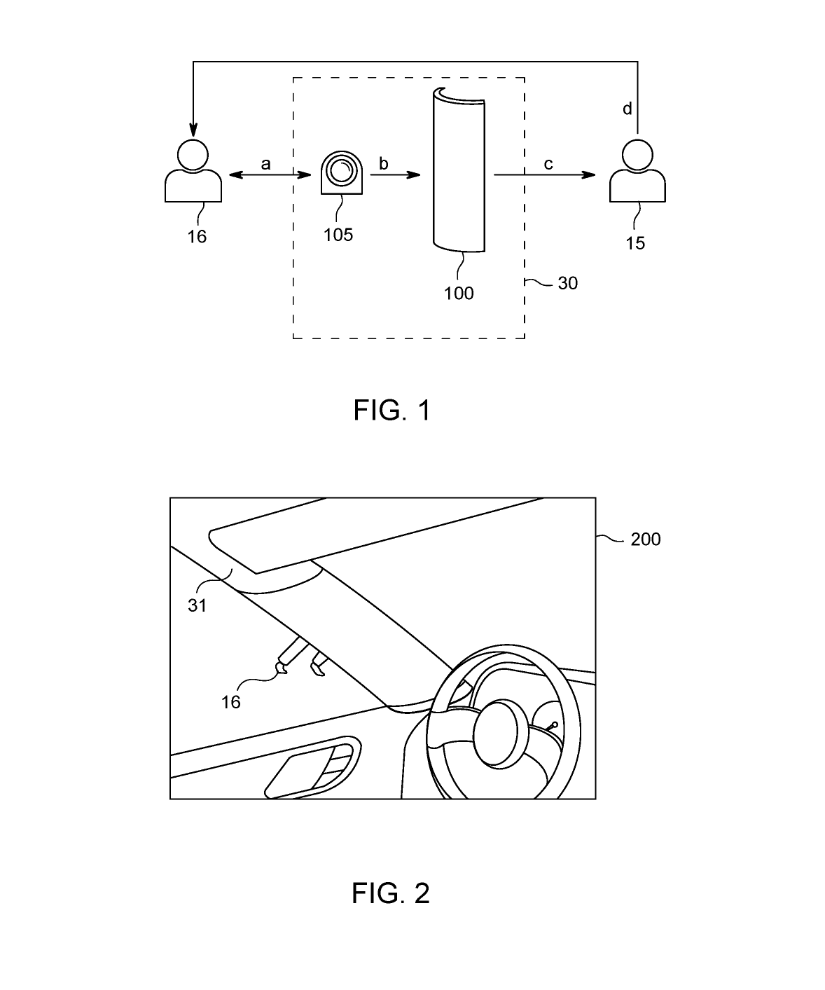

According to FIG. 1, the system view of an A-Pillar Video Monitor System showing passer-by (16), camera (105), video monitor (100) and driver (15) is shown.

Referring to FIG. 2, the inside view of a car showing passer-by (16) without an A-Pillar Video Monitor System is shown. The driver (15) can not see the passer-by (16) because of A-Pillar (31).

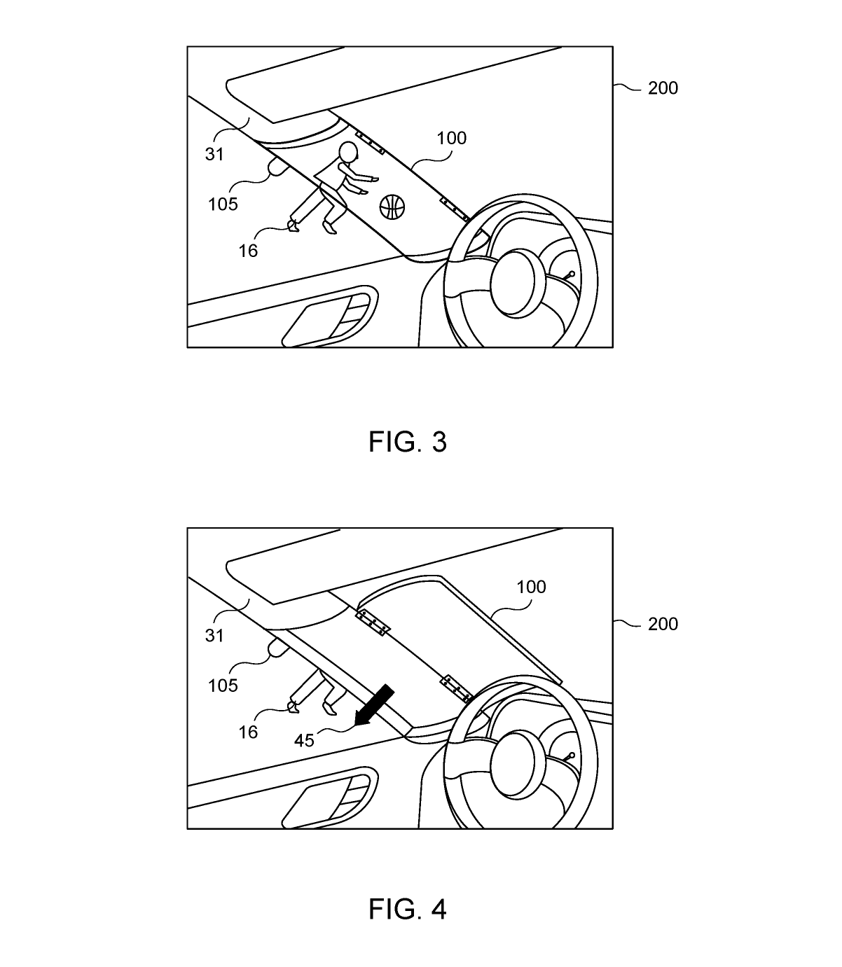

Referring to FIG. 3, the inside view of a car with an A-Pillar Video Monitor System showing passer-by (16) on the curved monitor (100) is shown. The video camera (105) is attached to A-Pillar (31). The passer-by (16) is displayed on the curved monitor (100) on A-Pillar (31).

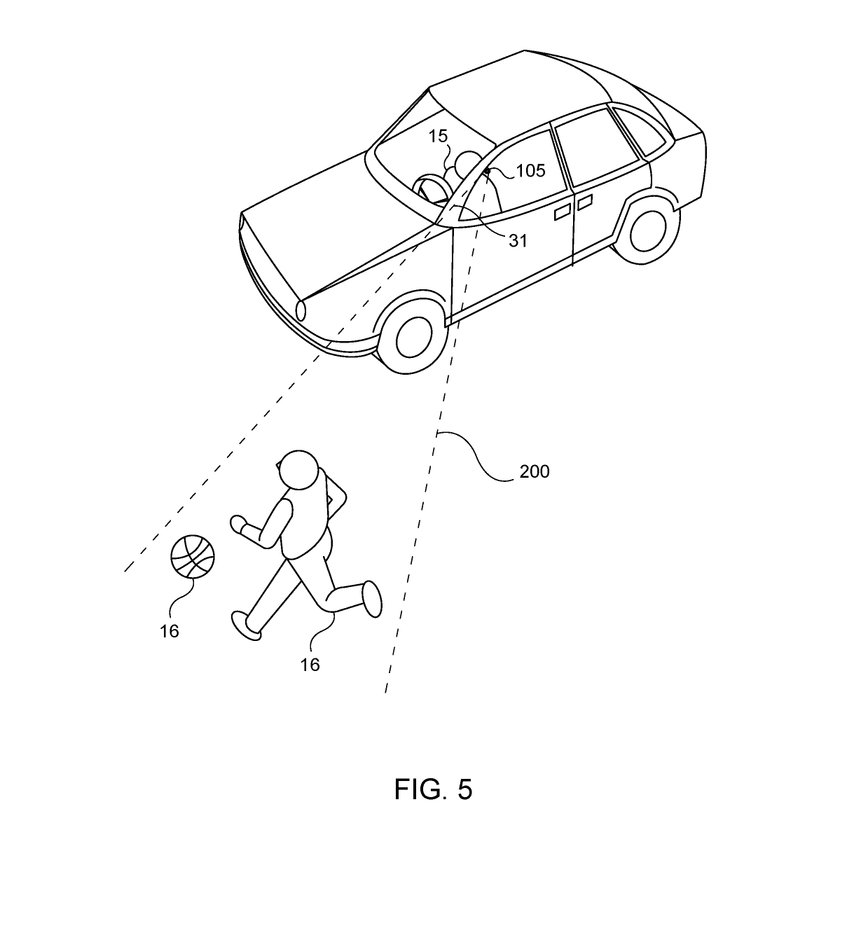

According to FIG. 4, the inside view of a car with an A-Pillar Video Monitor System showing passer-by (16) in an A-Pillar Video Monitor System in case of airbag (45) activation is shown. The curved monitor (100) is open when airbag (45) is deployed.

According to FIG. 5, the perspective view of an A-Pillar Video Monitor System showing passer-by with a ball (16), video camera (105) on the A-Pillar (31) and driver (15) is shown. The driver's view (200) is not interfered by the A-Pillar in the car.

1. A video monitor system comprising of a video camera, a monitor and A-Pillar.

2. A-Pillar of claim 1, wherein said a video camera is attached to A-Pillar.

3. A-Pillar of claim 1, wherein said a curved monitor is attached to A-Pillar.

4. A-Pillar of claim 1, wherein said an image from a video camera is displayed on a curved monitor.

5. A-Pillar of claim 1, wherein said a video image from a video camera is displayed on a curved monitor.

6. A-Pillar of claim 1, wherein said an airbag is installed inside A-Pillar.

7. A-Pillar of claim 1, wherein in case of airbag activation, a curved monitor is open and an airbag is deployed.
